(19) United States
(12) Patent Application Publication
(10) Pub. No.: US 2013/0195538 A1
(43) Pub. Date: Aug. 1, 2013

(54) ADHESIVE APPLICATOR

(71) Applicant: XYRON, INC., Scottsdale, AZ (US)

(72) Inventors: Braden Lloyd JONES, Phoenix, AZ (US); Christopher Michael POTTER, Phoenix, AZ (US); Chakrayud PIBOONTUM, Phoenix, AZ (US)

(73) Assignee: XYRON, INC., Scottsdale, AZ (US)

(21) Appl. No.: 13/740,017

(22) Filed: Jan. 11, 2013

Related U.S. Application Data
(60) Provisional application No. 61/586,060, filed on Jan. 12, 2012.

(51) Int. Cl. B05C 17/00

(52) U.S. Cl. CPC B05C 17/00
USPC 401/61; 401/55

(57) ABSTRACT

One aspect of the present invention provides an adhesive applicator in which the body of solid adhesive has an improved configuration. The applicator comprises a housing having a longitudinally extending internal chamber; a body of solid adhesive within the internal chamber of the housing; and an adhesive pusher for pushing the body of the solid adhesive forwardly within the internal chamber through an opening in a forward end of the housing. The body of solid adhesive has a longitudinal configuration between its ends defined by two essentially flat surfaces each meeting at an apex and a curved surface extending between the flat surfaces opposite the apex.

This application claims the benefit of U.S. Provisional Patent Application Ser. No. 61/586,060, filed Jan. 12, 2012, and incorporated in its entirety herein by reference.

### FIELD OF THE INVENTION

The present application is related to adhesive applicators, namely those of the type often referred to as glue sticks.

### BACKGROUND OF THE INVENTION

Typical glue-stick type adhesive applicators come in circular, triangular or rectangular cross-sections. None of these shapes are well-designed for optimal comfort, control or precision.

### SUMMARY OF THE INVENTION

One aspect of the present invention provides an adhesive applicator in which the body of solid adhesive has an improved configuration. The applicator comprises a housing having a longitudinally extending internal chamber; a body of solid adhesive within the internal chamber of the housing; and an adhesive pusher for pushing the body of the solid adhesive forwardly within the internal chamber through an opening in a forward end of the housing. The body of solid adhesive has a longitudinal configuration between its ends defined by two essentially flat surfaces each meeting at an apex and a curved surface extending between the flat surfaces opposite the apex.

In an embodiment, the internal chamber may have a longitudinal configuration between its ends defined by two essentially flat surfaces each meeting at an apex and a curved surface extending between the essentially flat surfaces opposite the apex, such that the internal chamber and the body of solid adhesive have matching lateral cross-sections. The housing may have a external longitudinal configuration between its ends defined by two essentially flat surfaces each meeting at an apex and a curved surface extending between the essentially flat surfaces opposite the apex.

Other objects, features, and aspects of the present invention will become apparent from the following detailed description, the accompanying drawings, and the appended claim(s).

### BRIEF DESCRIPTION OF THE DRAWINGS

FIG. 1 is a perspective view of an adhesive applicator according to an embodiment of the present invention;

FIG. 2 shows a cross-section of an adhesive body used in the application of FIG. 1 in comparison to a prior art adhesive body;

FIG. 3 shows side-by-side perspective views of the adhesive applicator of FIG. 1 along with prior art adhesive applicators;

FIG. 4 shows the same devices as FIG. 3 held for use to apply adhesive;

FIG. 5 shows side-by-side views of the adhesive applicator of FIG. 1 and a prior art adhesive applicator;

FIG. 6 is a perspective view of an end of the adhesive applicator of FIG. 1 with the cap positioned to be used to drive the adhesive pusher;

FIG. 7 is an end view of the forward end of the housing; and

FIG. 8 is a transparent view showing the internal adhesive pusher.

### DETAILED DESCRIPTION OF THE ILLUSTRATED EMBODIMENT(S)

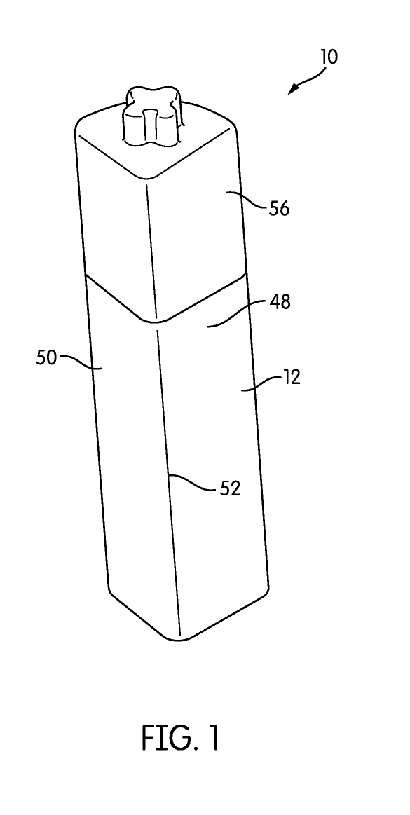

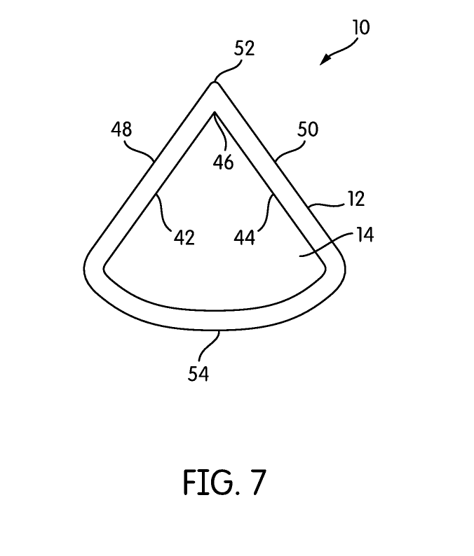

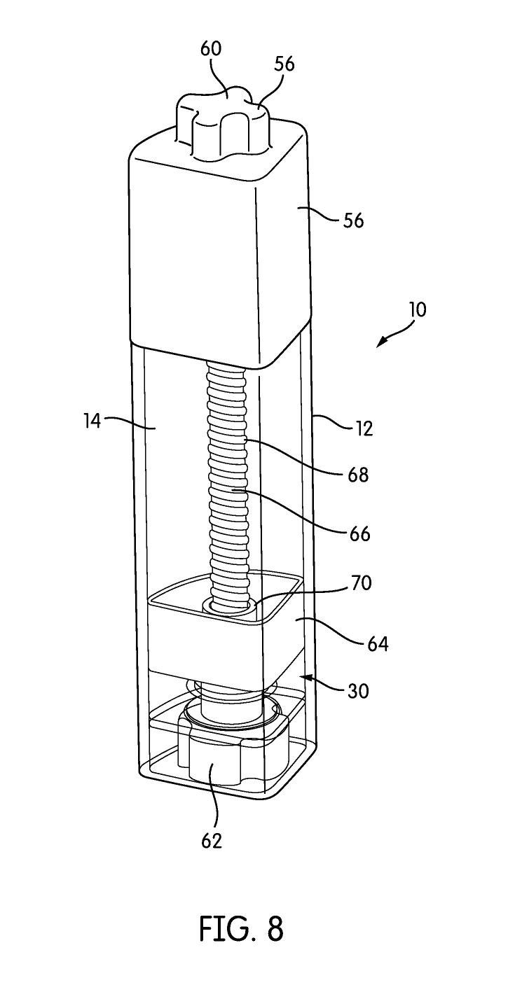

FIG. 1 shows a non-limiting embodiment of an adhesive applicator 10. The applicator 10 comprises a housing 12 having a longitudinally extending internal chamber 14 (shown in FIG. 7). A body of generally solid adhesive 16 may be disposed within the internal chamber 14 of the housing 12. This body of generally solid adhesive 16 may be made of material conventionally used in glue sticks, and is an adhesive in solid form that can be transferred to paper or another article by manually moving or wiping the body along the paper or article. Such adhesives are well-known and need not be described in greater detail.

The body of solid adhesive 16 may have a longitudinal configuration between its ends defined by two essentially flat surfaces 18, 20 each meeting at an apex 22 and a curved surface 24 extending between the essentially flat surfaces 18, 20 opposite the apex 22. The term essentially flat contemplates surfaces that are predominantly flat and would be regarded by one of ordinary skill in the art as being flat, but may not be perfectly flat and may have some slight curvature or imperfections. For example, certain molding techniques may benefit from a slight curvature to improve manufacturability. Of course, a truly flat surface is contemplated by this term as well.

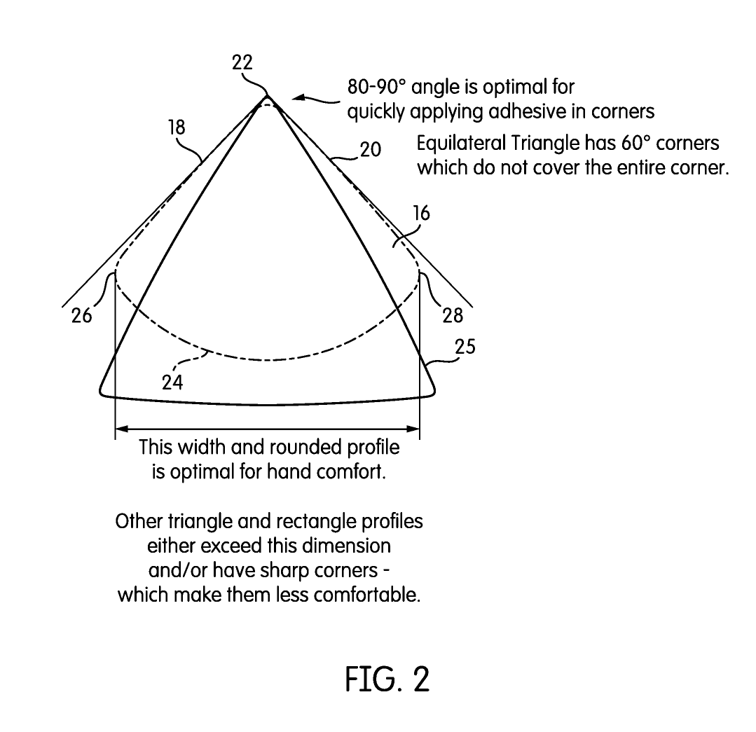

The cross-section of an embodiment of the adhesive body 16 is shown in FIG. 2, contrasted against a prior art body 25 having a cross-section shaped as an equilateral triangle. The apex 22 provides an improved contact area for applying adhesive to corners of paper or other articles. This is particularly the case where the two essentially flat surfaces 18, 20 of the body of solid adhesive meet at the apex 22 at an angle of 80 degrees or more. Preferably, the angle is in the range of 80-90 degrees. This cannot be achieved with an equilateral cross-section triangle cross-section, as the apices are all at 60 degrees and more acute. Moreover, the illustrated embodiment has apices 26, 28 where the curved surface 24 meets the flat surfaces that are also at a wider angle, again preferably more than 80 degrees and in the range of 80-90 degrees (this measurement is taken using a tangent line to the curved surface 24 where it meets a flat surface 18, 20). Again, it is impossible to achieve three wide angles with a triangular cross-section, since all angles must add up to 180 degrees. Circular (or more specifically cylindrical) adhesive bodies lack any corner and are difficult to use in a precise manner for corner application purposes.

Similarly, a prior art adhesive transfer device with a rectangular cross-section has corners that exceed 90 degrees. While a true rectangle has four 90 degree corners, because the walls have a slight convex curvature for manufacturing reasons, each corner slightly exceeds 90 degrees. Thus, when fully applying adhesive to a 90 degree corner of a document, some adhesive may be applied beyond the document edges, which is undesirable. With the device of the present application, the corner 14 can be made at or slightly less than 90 degrees for neat and precise corner applications.

The apices need not be perfect points, and may be slightly rounded. These surfaces may be deformed slightly due to the malleability of the solid adhesive and pressure applied to transfer the adhesive during use.

As is typical in such adhesive applicators, the applicator 10 may include an adhesive pusher 30 for pushing the body of the solid adhesive 16 forwardly within the internal chamber 14 through an opening 40 in a forward end of the housing 12. Embodiments of such a configuration are described further below.

The internal chamber 14 may have a longitudinal configuration between its ends defined by two essentially flat surfaces 42, 44 each meeting at an apex 46 and a curved surface 49 extending between the essentially flat surfaces 42, 44 opposite the apex 46. In some embodiments, the internal chamber 14 and the body of solid adhesive 16 may have matching lateral cross-sections (i.e., cross-sections taken perpendicular to the longitudinal axis of the applicator 10). Thus, the adhesive body 16 may be held firmly within the chamber 14 and may be pushed outwardly by the force of the adhesive pusher.

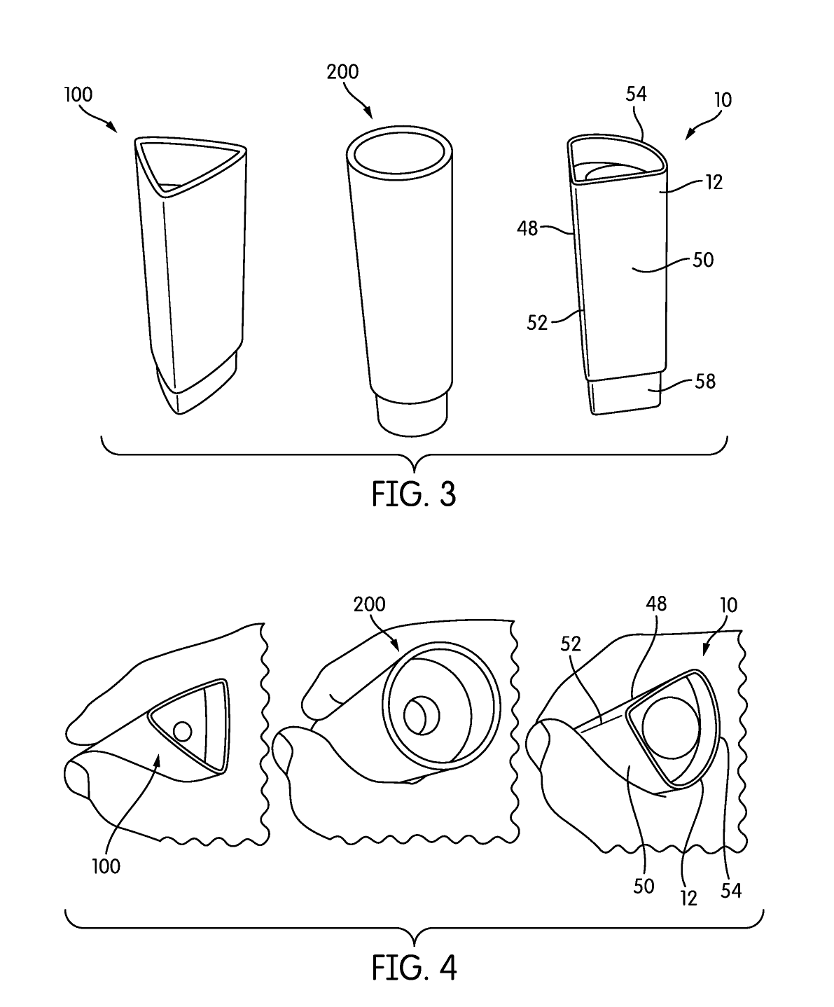

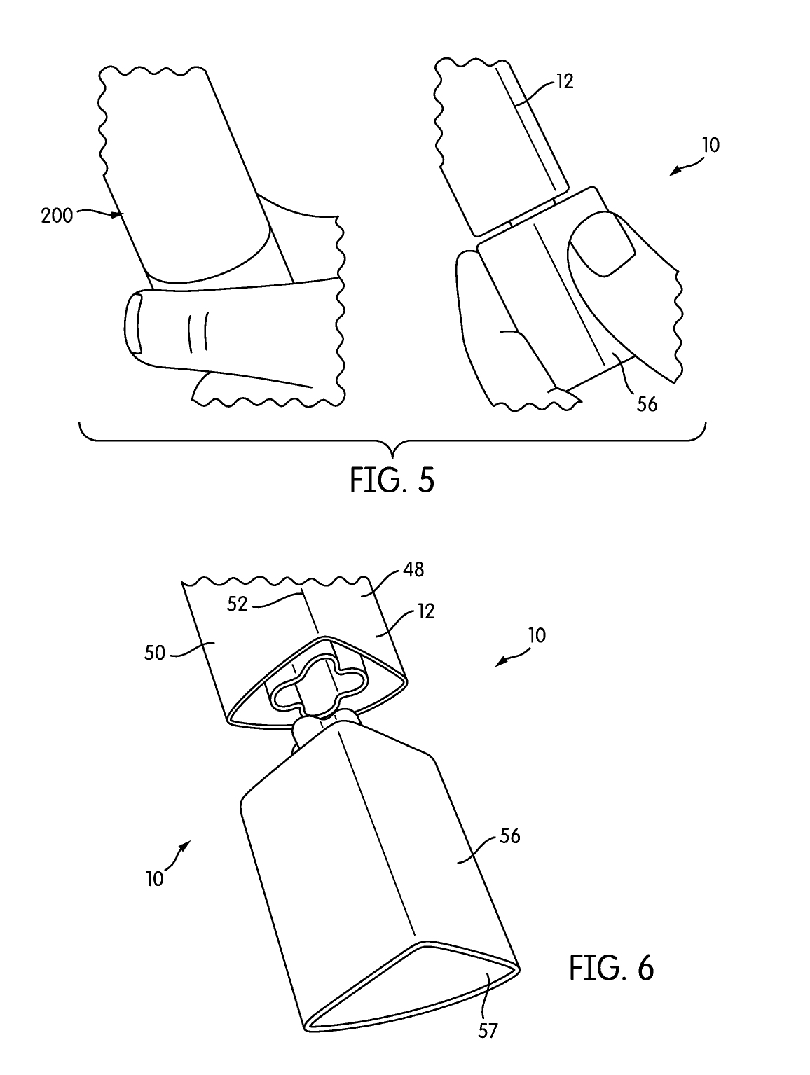

The housing 12 may also be defined by relatively thin walls defining a similar external longitudinal configuration. Specifically, in an embodiment the housing has a longitudinal configuration between its ends defined by two essentially flat surfaces 48, 50 each meeting at an apex 52 and a curved surface 54 extending between the essentially flat surfaces 48, 50 opposite the apex 52. Embodiment shaving such a configuration may have the advantage of helping the user to properly align the adhesive body 16 during use. Moreover, the housing 16 may have a more comfortable configuration for gripping during use. The shaping combines the more natural comfort of a cylindrical adhesive applicator (200 in FIG. 3) in the area of the curved surface 54 sitting against the user's hand, with the better control and accuracy of a triangular adhesive applicator (100 in FIG. 3), which is afforded by the essentially flat surfaces 48, 50 engaged by the user's fingers.

The applicator 10 also may include a cap 56 that mounts to the forward end of the housing 12 to close the opening 40. The cap 56 may have an internal chamber or recess 57 for fitting over the forward end of the housing 12, which may have a stepped or necked down portion 58 for receiving the cap 56.

The cap 56 also may include a coupler 60 that removably couples to a rotatable drive input 62 of the adhesive pusher 30 to enable rotation of the cap 56 to rotate the rotatable drive input 62. This may operate the adhesive pusher 30, as will be described below. The coupler 60 may have a non-circular male (e.g., protruding) configuration and the rotatable drive input 62 may have a similar non-circular female (e.g., receiving) configuration. In the illustrated embodiment, the coupler 60 has an X-shape with four members extending from its center, and the input 62 has the inverse of that shape. Other shapes could be used, such as a partial circle, square, rectangle, triangle, torx drive, polygon, etc, and the illustrated embodiment is not intended to be limiting.

The adhesive pusher 30 located within the housing 12 may comprise a pusher body 64 engaged with a rearward end of the body of solid adhesive 14 and coupled to the rotatable drive input 62 at the rearward end of the housing 12. The pusher body 64 may be movable longitudinally within the internal chamber 14. Specifically, the pusher body 64 may have a shape corresponding to the internal shape of the chamber 14 and may slide rectilinearly within the chamber 14 towards the forward end to push the adhesive outwardly from it.

The pusher 30 may also have a screw drive core 66 extending longitudinally within the internal chamber 14. The screw drive core 66 may have a helical external thread 68 extending along its length. In an embodiment, the pusher body 64 has an internal receiving opening 70 through which the screw drive core 66 extends. The internal surface of the opening 70 may have features, such as one or more lugs or internal threads that mesh with the external threads 68 on core 66. Thus, the pusher 30 is constructed to translate rotational movement of the drive input 62, which rotates the screw drive core 66, into longitudinal movement of the pusher body 64 to push the body of the solid adhesive 16 forwardly within the internal chamber through the opening in the forward end of the housing.

The foregoing illustrated embodiments have been provided solely for illustrating examples of structural or functional principles of the present invention and are not intended to be limiting. To the contrary, the present invention encompasses all modifications, alterations, substitutions, and equivalents within the spirit and scope of the following claims.

What is claimed is:

1. An adhesive applicator comprising:
a housing having a longitudinally extending internal chamber;
a body of solid adhesive within the internal chamber of the housing; and
an adhesive pusher for pushing the body of the solid adhesive forwardly within the internal chamber through an opening in a forward end of the housing;
wherein the body of solid adhesive has a longitudinal configuration between its ends defined by two essentially flat surfaces each meeting at an apex and a curved surface extending between the essentially flat surfaces opposite the apex.

2. An adhesive applicator according to claim 1, wherein the internal chamber has a longitudinal configuration between its ends defined by two essentially flat surfaces each meeting at an apex and a curved surface extending between the essentially flat surfaces opposite the apex, such that the internal chamber and the body of solid adhesive have matching lateral cross-sections.

3. An adhesive applicator according to claim 1, wherein the adhesive pusher is located within the housing, the pusher comprising a (a) pusher body engaged with a rearward end of the body of solid adhesive and movable longitudinally within the internal chamber, and (b) a rotatable drive input at a rearward end of the housing, the pusher being constructed to translate rotational movement of the drive input into longitudinal movement of the pusher body to push the body of the solid adhesive forwardly within the internal chamber through the opening in the forward end of the housing.

4. An adhesive applicator according to claim 3, further comprising a cap that mounts to the forward end of the housing to close the opening.

5. An adhesive applicator according to claim 4, wherein the cap includes a coupler that removably couples to the rotatable drive input to enable rotation of the cap to rotate the rotatable drive input.

6. An adhesive applicator according to claim 1, wherein the two essentially flat surfaces of the body of solid adhesive meet at the apex at an angle of 80 degrees or more.

7. An adhesive applicator according to claim 6, wherein the angle is in the range of 80-90 degrees.

8. An adhesive applicator according to claim 2, wherein housing has a external longitudinal configuration between its ends defined by two essentially flat surfaces each meeting at an apex and a curved surface extending between the essentially flat surfaces opposite the apex.
